(19) United States
(12) Patent Application Publication
(10) Pub. No.: US 2026/0035108 A1
(43) Pub. Date: Feb. 5, 2026

(54) Materials, Methods, and Apparatus for Lunar Engineered Regolith Infrastructure

(71) Applicant: David Malott, Secaucus, NJ (US)

(72) Inventors: David Iwami Malott, Jersey City, NJ (US); Connor McLeod, New York, NY (US); Leonel Herrera, Secaucus, NJ (US); Caela Gomes, Hoboken, NJ (US)

(73) Assignee: SpaceFactory Inc., Secaucus, NJ (US)

(21) Appl. No.: 18/634,888

(22) Filed: Apr. 13, 2024

(51) Int. Cl. B64G 99/00

(52) U.S. Cl. CPC B64G 99/00

(57) ABSTRACT

This invention details a comprehensive system for enhancing lunar regolith, enabling its use in constructing a range of structures and infrastructures on the lunar surface. This ‘engineered regolith’ significantly outperforms bulk, or naturally occurring lunar regolith, in terms of cohesion, frictional shear strength, and bearing capacity. Engineered regolith builds on certain advantageous properties of bulk regolith—namely its ability to be compacted to perform better—through targeted strategies to confine the regolith and prevent outwards shear failure. These strategies include beneficiation, fiber reinforcement, and polymeric stabilization in various combinations and concentrations to enable the construction of diverse structures, from habitat foundations to expansive infrastructures. In offering a sustainable and low-impact approach to lunar construction, this invention leverages in-situ resources to minimize the dependency on Earth-sourced materials. Moreover, its methodologies and benefits are extendable to Mars and beyond, underscoring the invention's position as a versatile construction technology with far reaching implications.

### FIELD OF THE INVENTION

The present invention relates to extraterrestrial construction and infrastructure development, specifically focusing on methods for enhancing lunar bulk regolith to improve its stability, strength, and workability. This advancement introduces methods, materials and apparatus to manufacture ‘engineered regolith’ as an improved construction material, markedly superior to bulk regolith, and suitable for a wide array of infrastructures on the lunar surface.

### BACKGROUND OF THE INVENTION

Lunar regolith, a byproduct of the Moon's geological activity, forms a fine, silty layer enveloping the lunar surface. Generated from eons of meteorite impacts, solar wind, and thermal cycling, the regolith's median particle size falls between 40 to 130 μm, averaging around 70 μm. Due to the Moon's arid conditions, lunar regolith lacks the adhesion that benefits Earth's soils, resulting in a top layer around 20 to 30 cm deep that is characterized as loose and fluffy, as observed during the Apollo missions.

Beneath this surface, lunar regolith demonstrates increased cohesion and shear strength when compacted. The angularity and unique shapes of its particles facilitate mechanical interlocking, critical for cohesion in compacted states. Deeper layers of regolith, naturally compacted over millennia by thermal cycling, exhibit high densities and increased frictional shear strength, enabling stable excavation up to depths of 3m.

Recognizing these inherent properties, the invention employs a process that mimics and enhances the Moon's natural processes to bolster the structural integrity of regolith-based constructions. Vibrational compaction emerges as a foundational method which significantly enhances the shear strength and bearing capacity essential for infrastructure development like roads and landing pads.

However, unconfined regolith surfaces are susceptible to erosion from dynamic interactions, such as astronaut movements, vehicle traffic, and rocket plumes, underscoring the necessity for confinement strategies. Experiments with lunar simulants demonstrate that when unconfined, compacted regolith has an ultimate bearing capacity of approximately 16 kPa, whereas its confined variants exhibit dramatically increased bearing capabilities, by a factor of 100x or more.

Building on these insights, the invention introduces holistic engineering strategies to compact and confine regolith effectively. By capitalizing on regolith's natural potential and refining its application through beneficiation, compaction, and stabilization techniques, the invention paves the way for constructing durable, high-performance lunar structures. The focus is on efficiency and sustainability, with operative metrics targeting low launch mass (requiring Earth-brought materials to constitute less than 2% of the construction mass) and low energy consumption (less than 2% of the power relative to laser sintering), presenting a novel and impactful approach to building with lunar regolith.

### BRIEF SUMMARY OF THE INVENTION

This invention pertains to the optimization of lunar regolith for infrastructure construction on planetary surfaces, introducing a refined material hereafter referred to as ‘engineered regolith.’ Engineered regolith builds on vibration compaction as a method to approximate the Moon's natural compaction processes for enhancing regolith, with additional methods, compositions, and implement to consolidate, constrain, and construct engineered regolith structures.

One advancement is the strategic reorganization of the regolith's particle size distribution. By systematically sorting and recombining particles to achieve an optimal packing ratio, engineered regolith achieves enhanced density and mechanical properties. This methodological development, along with vibration compaction, improves the cohesiveness, frictional shear strength, and bearing capacity of the regolith, distinguishing engineered regolith from its bulk counterpart.

To counteract the progressive erosion and subsequent structural weakening induced by dynamic surface interactions, this invention introduces several confinement strategies. These strategies are designed to ensure the long-term stability and integrity of regolith-based constructions, particularly in response to surface activities and lunar seismic events. This approach includes the adaptation of terrestrial construction techniques, such as geogrids for mechanical stabilization and the use of polymers for chemical stabilization, tailored for the lunar environment.

A critical aspect of this adaptation is polymer additives to enhance the regolith's structural properties for surface stabilization. Given water scarcity on the Moon and challenges posed by off-gassing from hydrated mixtures in vacuum, this method involves dry-mixing polymers in solid form—powders, granules, or pellets—with regolith in variable concentrations, with a focus on increasing concentrations towards the outer layers for optimized confinement.

Upon application, targeted heat activation bonds the polymer palliatives to the regolith particles, primarily at the surface, creating a durable crust that significantly improves the material's shear strength and erosion resistance. This surface crust acts as a barrier, enhancing the structural integrity of the underlying regolith, which remains primarily stabilized through vibration compaction.

Another enhancement involves the deployment of lunar geogrids, analogous to their terrestrial equivalents but tailored for the lunar environment. These geogrids are horizontally layered within the regolith structure and serve to constrain the form. When combined with polymer palliatives and heat-activated, the polymers melt and fuse, securely bonding the outer crust to the internal geogrid.

Lastly, this invention introduces implements designed to aid in the formation and construction of varied engineered regolith structures. Subsequent descriptions will detail the tools and techniques for heating, compacting, and molding engineered regolith into specific forms. The technology harbors a wide array of potential applications, including but not limited to, launch and landing pads, towers, habitats, pathways for enhanced trafficability, radiation shields, subgrade access structures, meteoroid impact protectors, operational platforms for equipment, and solutions for dust mitigation.

By advancing the capabilities of regolith as a construction material, this invention lays the foundation for a sustainable human presence on the Moon and beyond. It not only facilitates the realization of future lunar missions but also significantly contributes to the development of infrastructure critical for future extraterrestrial exploration and multiplanetary habitation.

### BRIEF DESCRIPTION OF THE SEVERAL VIEWS OF THE DRAWING

Detailed embodiments of the invention are discussed below with reference to the accompanying drawings, in which:

FIG. 1 is an illustration of foundational infrastructures constructed from engineered regolith;

FIG. 2 is a schematic cross-section of an engineered regolith structure used to shield a habitat module, demonstrating a combination of methods disclosed in this invention;

FIG. 3 is a schematic cross-section of a compaction head which forms part of a compaction implement;

FIG. 4 is a schematic cross-section of a compaction head which takes the form of a roller, demonstrating the versatility of the system;

FIG. 5 is a schematic worm's eye perspective of the compaction plate with variations;

FIG. 6 is a schematic cross-section of an integrated system for preparing engineered regolith including a compaction implement and expandable formwork implement, used in constructing an engineered regolith structure with variable polymer concentrations;

FIG. 7 is a schematic perspective of an engineered regolith delivery system including a reversible excavation drum and polymer dispensing system;

FIG. 8 is a schematic diagram of an autonomous construction system connected to a digital twin, where a structural analysis performed on the digital twin informs the activities of the autonomous construction system;

FIG. 9 is a schematic diagram of a passive solar system for heating engineered regolith.

### DETAILED DESCRIPTION OF THE DRAWING

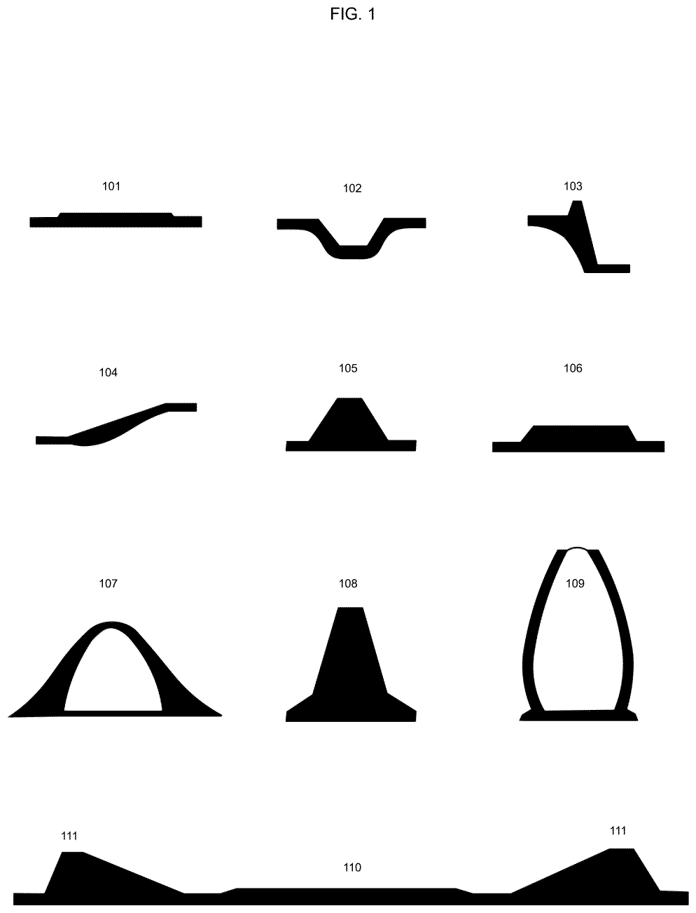

FIG. 1 illustrates foundational infrastructures constructed with engineered regolith, beginning with Transportation and Access Infrastructure including roads 101 and utility trenches 102, retaining walls 103 for landscape stabilization, and ramps 104 to traverse uneven terrain. Equipment and Facilities Infrastructure encompasses equipment pedestals 105, prepared surfaces 106, and plinths 108 to elevate solar towers above the surrounding terrain. Habitation Infrastructure focuses on effective protection from the lunar environment, including regolith overburden structures 107 and habitat shells 109. Launch and Landing Infrastructure includes landing pads 110 and berms 111 designed to divert rocket plume exhaust away from adjacent infrastructure.

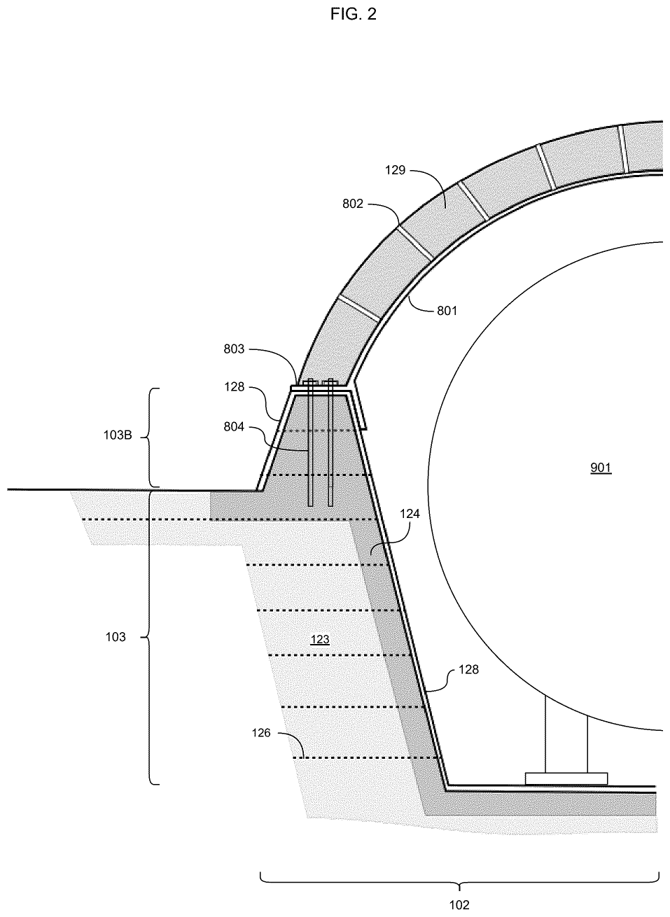

FIG. 2 depicts a regolith overburden structure shielding a semi-submerged habitat module 901 from space radiation and micrometeorite impacts. The habitat module sits within an excavated trench 102 lined with an engineered regolith retaining wall 103, designed to prevent structural failure in a lunar seismic event. The trench is over-excavated then backfilled with beneficiated and compacted regolith 123 with lunar geogrid 126 laid between horizontal compaction layers. The surface region 124 is further reinforced with 0.1% to 2.0% dry polymer additives which are heat activated with formwork panels to bind the regolith. Once set, the formwork panels stand off from the retaining wall to create a small gap. A sticky regolith slurry made with 2.0% to 3% polymer additives is then poured into the gap and vibrated, forming a smooth finish layer 109.

The overburden structure is constructed by placing an Earth-manufactured aluminum vault 801 with aluminum support ribs 802 which also serve to retain engineered regolith infill 127. The aluminum vault features a continuous L-shaped sill plate 803 which bears down on a continuous parapet 112 with cast-in anchor bolts 804 extending up from the retaining wall. The parapet serves to both anchor the vault and counteract its outwards thrust, as well as to protect against any vehicles which might impact the vault. The vault is secured to the anchor bolts then finally covered with regolith overburden for radiation shielding.

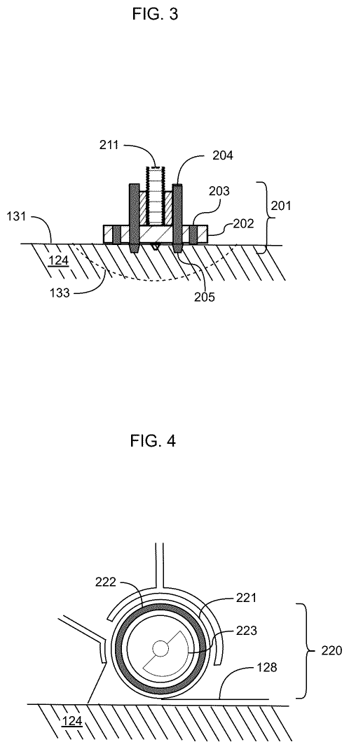

FIG. 3 illustrates one variation of the compaction head 201 consisting of a compaction plate 202 integrated with heat cartridges 203 and vibrating motors 204. Vibrating fingers 205 extend below the compaction plate to induce vibrations beneath the regolith surface 130. The compaction implement is used to compact a dry mixture of regolith with polymer additives 124 then heat a subsurface region 133. The compaction head is attached to a linear rail 211 to apply downward pressure.

FIG. 4 depicts a second variation of the compaction head 220 which includes a roller 221 with integrated heater bands 222 and an offset vibrating motor 223. The roller drives along a pre-prepared surface 124, to compress a sticky regolith slurry, leaving a smooth finish surface 128.

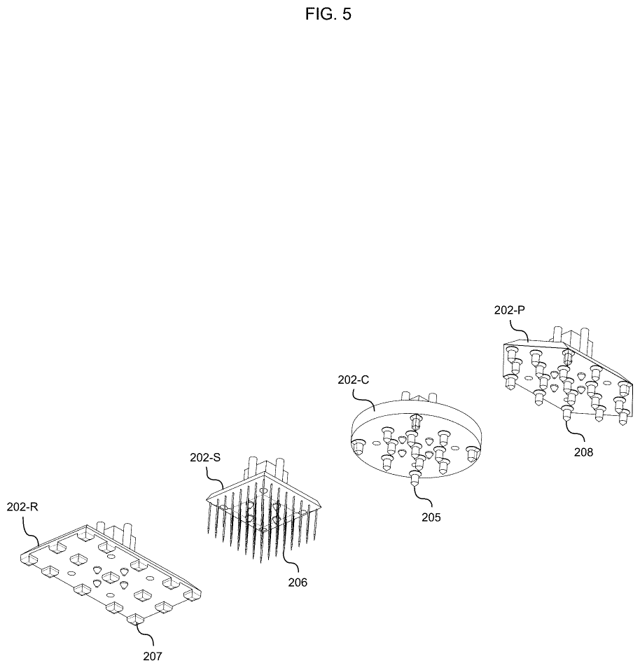

FIG. 5 illustrates possible variations of a circular compaction plate 202-C with vibrating fingers 202, a beveled square 202-S with vibrating needles 206, a beveled rectangle 202-R with protruding studs 207, and a polygon 202-P with fixed cleats 208.

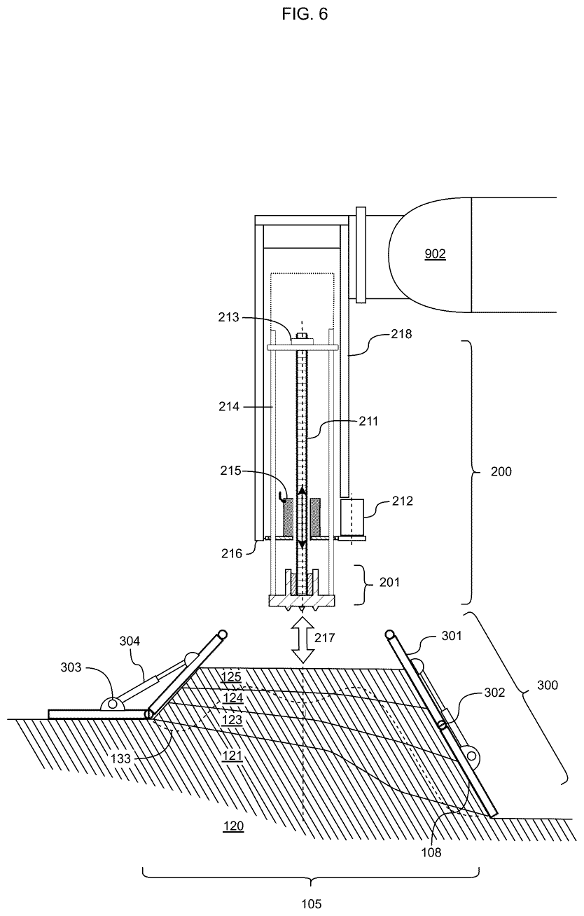

FIG. 6 shows an integrated system, comprising a compaction implement 200, expandable formwork system 300, and an engineered regolith equipment pedestal 105 during the construction process. A compaction implement 201 is mounted on a linear rail 211 driven by a linear motor 215 which moves the compaction plate up and down in a tamping motion 217. In one variation, a servo motor 212 rotates a gear 216 which turns two vertical rods 214 connected about a pivot 213, wherein the mechanism rotates the compaction plate to reach areas otherwise obstructed by the formwork system. The compaction implement is housed within a protective shroud 218 and mounted to a travelling gantry or robotic arm 902.

Starting at the undisturbed layer of bulk regolith 120, the system constructs a layer of compacted regolith 121, a layer of beneficiated and compacted regolith 122, and a layer of beneficiated and compacted regolith with <1% polymer additives. The compaction implement is then used to prepare a layer of beneficiated and compacted regolith with 1-2% polymer additives 125. This last layer is stronger than the underlying layer in anticipation of stress concentrations when the equipment is anchored into the pedestal.

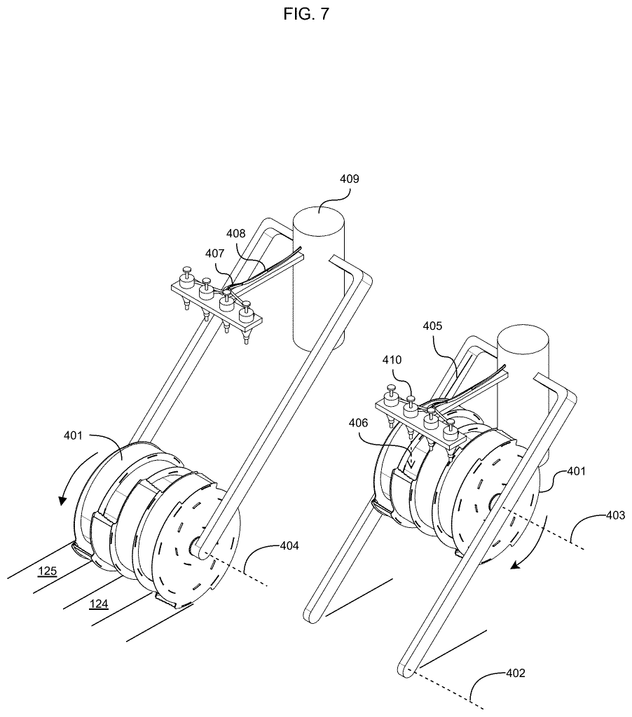

FIG. 7 illustrates one implementation of a regolith delivery system 400 used in collaboration with an excavating drum 401, as described in U.S. Pat. No. 9,027,265 B1, issued to the National Acronautics and Space Administration on May 12, 2015. The excavating drum is raised from its excavating position 402 to a loading position 403. A strain gauge 405 weighs the drum to determine the mass of regolith contained. A polymer dispenser 410 releases a precise amount of polymer pellets 406 into one section of the drum. The mass of polymer pellets is determined by the regolith mass multiplied by the specified polymer concentration. The excavating drum is spun in one direction until each drum section is loaded and the mixture is mixed. The drum is moved to an offloading position 404 and is spun in an opposing direction to deposit the regolith-polymer mixture 125 and a regolith-polymer mixture at a relatively lower concentration 124. The polymer dispenser is reloaded by opening a solenoid valve 407 which is connected to a pressurized reservoir 409 via a feed tube 408.

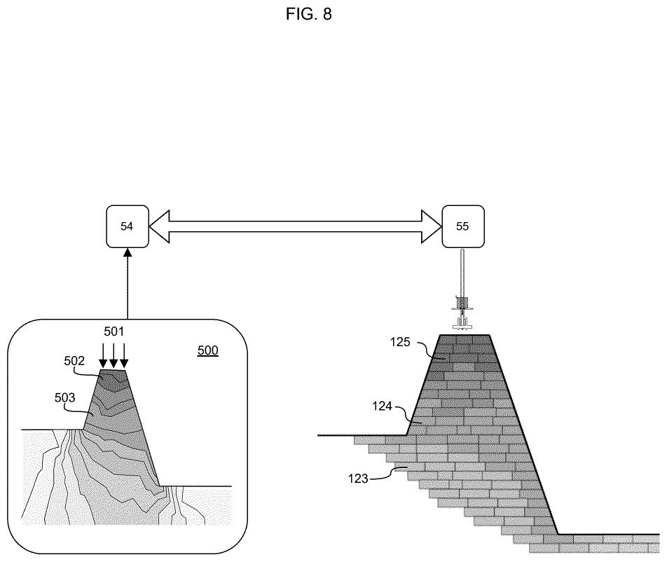

FIG. 8 illustrates the concept of a digital twin 500 paired with its physical counterpart, an engineered regolith plinth 108 designed to elevate a 20 kW solar tree above the surrounding terrain. The results of a finite element analysis using the design load 501 generate stress contours indicating regions of relatively higher stress 502 and relatively lower stress 503. The stress values are mapped to polymer concentration values 504 referenced by a control system 505. The control system moves the compaction implement and adjust the polymer delivery rate to construct the plinth starting with a layer of compacted and beneficiated regolith 123, a layer of beneficiated and compacted regolith with <1% polymer additives 124, and a layer of beneficiated and compacted regolith with 1-2% polymer additives 125. undisturbed bulk regolith 120 which correlates to values mapped in the digital twin. The construct is heated to a depth 6 below the surface to activate the regolith-polymer mixture to achieve the strength characteristics informed by the structural analysis.

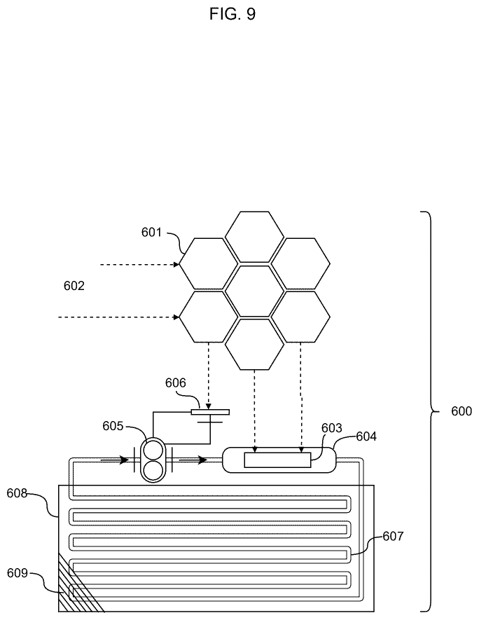

FIG. 9 illustrates a passive thermal generation system 600 equipped with a heliostat 601 that redirects sunlight 602 to a solar collector 603. The solar collector regulates the amount of sunlight to warm a fluid transfer medium includes a shutter mechanism to regulate the amount of sunlight through the window. Sunlight heats a fluid medium, specifically perfluoropolyether (PFPE), contained in a reservoir 604. PFPE is chosen for its excellent thermal stability and non-reactivity, making it suitable for extreme temperature ranges as experienced at the lunar surface. A positive displacement pump 104, powered by a solar panel 105, circulates this heated liquid medium through channels 106 integrated into a conductive formwork panel 107. The outboard face of the formwork panel is covered with multi-layer insulation 108 to prevent radiative heat loss.

### DETAILED DESCRIPTION OF THE INVENTION

### Embodiment 1: Engineered Regolith Infrastructures

This embodiment encompasses infrastructures constructed from engineered regolith, enhanced through the inventive methods and materials described herein. Designed to support lunar missions, these foundational infrastructures are pivotal for establishing and maintaining a long-term human presence on the lunar surface.

### Sub-Embodiment 1.1: Launch and Landing Infrastructure

This category encompasses infrastructure essential for launch and landing operations on the Moon. It includes regolith-based launch/landing pads and communications tower foundations engineered to endure the dynamic forces and exhaust plumes of spacecraft operations. Additionally, regolith berms are devised to contain and redirect launch/landing plumes, safeguarding nearby assets and surface activities from disruptive effects.

### Sub-Embodiment 1.2: Equipment and Facilities Infrastructure

This classification covers structures facilitating equipment and operational support. Examples include equipment pedestals and prepared surfaces which are levelled, compacted and dust-free. Additionally, it includes maintenance sheds to ensure the longevity and reliability of lunar rovers and equipment.

### Sub-Embodiment 1.3: Transportation and Access Infrastructure

This group involves infrastructures that enhance mobility and resource accessibility on the lunar surface. It features regolith-based tunnels and trenches for subsurface access and asset storage, roads and pathways for improved rover and astronaut traversal, sloped ramps for accessing elevated terrains, and retaining walls for landscape stabilization and erosion control.

### Sub-Embodiment 1.4: Habitation Infrastructure

Focused on safeguarding mission assets and personnel, this category includes meteoroid impact protection structures and dust mitigation surfaces to preserve equipment functionality. Additionally, it outlines the construction of observation platforms for environmental monitoring and radiation shielding to enhance protection against solar particle events (SPEs) and galactic cosmic radiation (GCR).

### Embodiment 2: Engineered Regolith Preparation

This embodiment details the process of preparing engineered regolith, which is optimized from its natural state for use in constructing various lunar infrastructures. The method involves a series of preparatory steps that ensure the regolith is ideally suited for subsequent construction techniques.

### Sub-Embodiment 2.1: Regolith Beneficiation

Bulk regolith is systematically sieved to separate larger particles ranging from approximately 0.5 mm to 2 mm from the smaller fines (particles below the threshold size). Of the fines, between 40%-60% by mass is removed. This separation allows for a more efficient packing ratio, where larger particles interlock to create a stable microstructure with fines filling the interstitial voids. This reorganization improves the frictional shear strength, enhancing the overall cohesion and stability of the regolith composition. The remaining separate fines are reserved for other in-situ resource utilization (ISRU) processes, promoting a sustainable use of all extracted materials.

### Sub-Embodiment 2.2: Incorporation of Polymer Additives

For this disclosure, the term ‘polymer additive’ describes polymer-based materials applied in specific quantities to engineered regolith. These materials are intended to enhance physical properties such as cohesion, shear strength, and bearing capacity. It refers to not only to thermoplastic materials but geopolymers and exopolysaccharides that may be derived from lunar or terrestrial sources and include materials used for surface stabilization, binding, or protective coatings.

A portion of the beneficiated regolith is mixed with dry polymer additives in the form of powder, granules, or pellets. Preference is given for polymer additives that can be traced back to lunar-derived resources, such as mission waste, byproducts from other in-situ resource utilization (ISRU) activities or those synthesized directly from water ice or volatiles found in permanently shadowed regions (PSRs).

The concentration of these polymer additives within the regolith mix varies, with higher concentrations applied towards the surface to create a confining crust, and in areas identified through simulation and modeling as subject to localized stress concentration. This select optimization of polymer additives is designed to ensure targeted strengthening and durability where it is most crucial, reducing the polymer mass to between 0.5 to 2% of the overall construction mass.

The benefit of pre-mixing dry polymer additives lies in its relative simplicity when compared to electrostatic spraying or working with hydrated mixtures in a vacuum. This method is also less susceptible to the Moon's temperature fluctuations, allowing it to be conducted at a continuous pace and stockpiled until conditions are ideal for follow-on construction activities. Additionally, pre-mixing enables thorough testing and verification of the material to ensure the correct constituent mix, ensuring repeatable and reliable results.

### Sub-Embodiment 2.3: Applications Involving the Use of Hydrated Polymers

While the core innovation of this invention emphasizes dry mixing of polymer additives for lunar regolith stabilization, it also accommodates ‘wet’ process alternatives to ensure versatility across different lunar resources and conditions. These alternatives, which include the use of geopolymers and exopolysaccharides (EPS), offer unique benefits and adapt distinct preparation methods. To address the challenges of water sublimation in the vacuum of space, a closed-loop system is necessary for both methods to capture and recycle water efficiently.

Geopolymers, derived from lunar regolith aluminosilicates through ISRU processes, are activated with an alkaline solution, such as sodium or potassium hydroxide mixed with water or icy regolith to form a slurry that binds regolith particles effectively. This method operates at lower temperatures than thermoplastics, optimizing the use of lunar minerals and minimizing energy consumption.

Exopolysaccharides (EPS), which can be produced through bio-mining of lunar regolith, introduce a biological dimension to regolith stabilization. EPS is produced as a byproduct by microbial cultures in a regolith and starch broth. In an ideal method, EPS is cultivated in a bioreactor until the starch is consumed, yielding a regolith slurry which is heated to gelatinization around 60-80° C. then cast within formwork or trowelled on as a durable finish layer.

### Sub-Embodiment 2.4: Electrostatic Spraying

Electrostatic spraying of polymer powders can exploit the unique environmental characteristics of the Moon, where lunar dust is charged by the solar wind. In theory, giving the polymer spray an opposite charge could improve adhesion to the naturally charged regolith, potentially optimizing surface coating uniformity. However, this method introduces significant challenges. The dynamics of spraying and charged regolith interaction are complex, requiring controlled experiments in vacuum and low-gravity conditions. Moreover, the need for specialized equipment that can operate reliably in lunar conditions-handling extreme temperature fluctuations and vacuum-adds to the complexity and demands rigorous process control.

### Embodiment 3: Engineered Regolith Fiber Reinforcement

This embodiment enhances the structural integrity of regolith constructions through the integration of fiber reinforcement, whether as individual fibers or formed into geogrids. Preference is given for fiber materials potentially derived from ISRU processes.

### Sub-Embodiment: 3.1 Fiber Material Reinforcement

This section focuses on various types of fibers that can reinforce lunar regolith, each sourced through ISRU to ensure sustainability and feasibility on the Moon:

Basalt Fibers produced by melting and extruding lunar basalt, potentially using concentrated solar heating to reduce energy demands.

Plant-Based Fibers from biowaste such as bagasse, which is neither a food source nor suitable for biopolymer production due to its resistance to chemical and enzymatic hydrolysis.

Synthetic Fibers made from biopolymers derived from inedible biomass, or polymers synthesized from hydrocarbon resources extracted from PSRs or recovered from excess rocket propellant.

### Sub-Embodiment 3.2: Geogrid Reinforcement

Building upon the fiber reinforcement strategies, this section outlines the method of forming lunar geogrids. These geogrids are created by weaving basalt fiber, plant-based fibers, or synthetic fibers.

When layered between regolith strata, these geogrids help arrest diagonal shearing forces along the angle of internal friction by laterally distributing shear forces across the grid. This integration effectively engages the entire compacted core of the structure, enhancing its stability and load-bearing capacity.

### Embodiment 3.3: Engineered Mesh Reinforcement

This embodiment details the development and integration of an engineered mesh reinforcement designed to enhance the mechanical properties of regolith-based structures on lunar or other extraterrestrial surfaces. The engineered mesh is specifically tailored to interact optimally with a regolith mixture whose particle size distribution has been adjusted through beneficiation processes to maximize packing density and mechanical interlock.

Mesh Design: The mesh features a diagrid pattern, utilizing triangular configurations to optimize the distribution of stresses within the structure. The triangular mesh elements are designed to be compatible with the particle size distribution of the beneficiated regolith, ensuring that the mesh openings are appropriately sized to prevent the passage of larger regolith particles while allowing finer particles to fill interstitial voids, thereby enhancing the overall structural integrity.

Mesh Material: The mesh is fabricated from a polymer material suited for extraterrestrial environments, chosen for its strength, flexibility, and compatibility with the regolith-polymer mixture used in construction. The polymer is ideally sourced from in-situ resources, aligning with the sustainability goals of extraterrestrial construction efforts.

Mesh Functionality: The mesh acts as a geogrid within the regolith structure, distributing loads evenly and reducing the likelihood of shear failures, especially in load-bearing applications or where diagonal shearing forces might be anticipated.

Reinforcement Tuning: The mesh thickness, strand diameter, and open area ratio are all variable parameters that can be optimized based on the specific engineering requirements of the construction project. This customization allows the mesh to provide necessary reinforcement precisely where it is most needed, such as in walls and foundations subject to dynamic stresses from lunar seismic activity or thermal cycling.

Integration with Regolith Mixtures: The mesh is designed to be fully integrated during the compaction process, where it can be laid in layers between courses of regolith or embedded within a single thick layer, depending on the design specifications. This integration is facilitated by the mesh's material properties, which allow it to bond effectively with the polymer-enhanced regolith upon heat activation.

### Heat Activation Compatibility:

The polymer material of the mesh is selected to be responsive to heat activation techniques used in lunar construction. This ensures that when the regolith-polymer mixture is heated to activate the binder, the mesh simultaneously bonds to the regolith, creating a monolithic composite material that exhibits significantly enhanced load-bearing and environmental resistance properties.

Practical Application: In practice, this mesh is used in various structural applications ranging from foundational supports to protective barriers and load-bearing walls. Its introduction into the regolith construction process is a pivotal step that leverages advanced materials engineering to solve traditional challenges in lunar construction, such as those posed by the non-cohesive nature of lunar regolith and the extreme environmental conditions of space.

### Embodiment 4: Engineered Regolith Compaction Methods and Implements

This embodiment concentrates on a compaction method and implement designed to consolidate engineered regolith, essential for achieving the desired mechanical properties in lunar construction materials. The implement is engineered to apply a tamping or vibrating force, compacting of the engineered regolith mixture through a variety of mechanical and thermal techniques. The compaction implement can take the form of a plate or roller, each equipped with features that enhance the effectiveness of the compaction process:

Vibrating Mechanism: This compaction implement is actuated to provide either a tamping or vibrating force. In one variation, the implement includes fingers or needles that extend from the contact surface to penetrate deeper within the regolith layer, inducing vibrations.

Heating Mechanism: This implement not only compacts the mixture but can also be integrated with heating pads or cartridges to provide targeted heating to activate the polymer-regolith mixture.

Regolith Dispensing Mechanism: This implement may also contain an integrated dispensing mechanism, such as an auger, chute or feed tube, to meter and deposit the polymer-regolith mixture in a controlled manner.

### Embodiment 5: Engineered Regolith Formwork System

The formwork system described herein provides crucial temporary support during the compacting and heating processes necessary for constructing three-dimensional regolith-based structures. It is designed to accommodate and enable the construction of complex geometries, ensuring conformance to precise design specifications. This system incorporates various innovative strategies, each potentially suitable for different construction scenarios on the lunar surface:

Slipform System: Features mechanisms allowing vertical or horizontal movement of the formwork. As regolith is compacted and cured, the system gradually moves to facilitate the continuous construction of walls, trenches, berms, or other structures.

Expandable Formwork: Consists of lightweight, foldable components that are easily transported and deployed. This adaptable formwork is expanded into the desired shape on-site, filled with regolith, and then compacted.

Inflatable Formwork: Designed for compact transport and inflated into the required shape at the construction site. After the regolith cures, the formwork is deflated and removed, leaving a structurally sound regolith form.

Robotic Formwork System: Employs autonomous adjustment to meet the specific requirements of each structure, facilitating precise control over the shape and dimensions with modular components and adjustable joints.

3D Printed Formwork System: Utilizes in-situ 3D printing from regolith-based materials to create formwork components directly on the lunar surface, significantly reducing the need for Earth-based resources and transport.

Heated Formwork: Integrates heating elements to activate the regolith-polymer mixture, using devices such as embedded heat cartridges or pads, potentially enhanced by passive solar collectors.

Vibrating Formwork: Incorporates elements that induce vibrations, such as embedded vibrating fingers or externally attached motors, to improve compaction efficiency.

Formwork with Integrated Material Delivery: Features a built-in system that precisely releases additives like polymeric binders, fibers, or basalt aggregate into the regolith during compaction, optimizing the material properties of the final structure.

The expandable formwork system confines the regolith as the equipment pedestal is constructed. Comprised of fixed formwork panels 301 which are hinged about panel joints 302, the expandable formwork system is designed to conform to the level difference in the site. The panels are rotated using a linear actuator 304 with a hinged or slotted connection 303. In addition to providing confinement, the expandable formwork system is integrated with a heating system which, together with the heated compaction implement, activates the polymers additives to the depth of the heated region 136.

### Embodiment 6: Engineered Regolith Delivery System

An embodiment of the invention, wherein an engineered regolith delivery system provides precise control over the amount of polymer powder, granules, or pellets added to the regolith. This results in a more optimized use of resources and enables the creation of structures with varying strength and stability characteristics.

The engineered regolith delivery system includes a reversable excavating drum, a reservoir for storing the polymer, and a control system for regulating the delivery rate. A metering device controls the rate at which polymer pellets exit the reservoir into the conveying mechanism. The conveying mechanism may be incorporated to move the feed tube containing a flexible auger, or a conveyer belt, or a vibrating trough. The system is calibrated by measuring the depth and weight of pellets remaining in the reservoir.

Overall, this polymer delivery system provides precise control over the delivery rate of the polymer and ensures a consistent mix of the regolith and polymer, resulting in optimized material properties for each specific construction task.

### Embodiment 7: Autonomous Construction Systems for Engineered Regolith

Another embodiment of the present invention includes the use of autonomous systems to operate the implement for regolith stabilization. In this embodiment, the implement is designed to be operated by a robotic system, which minimizes the need for human intervention and reduces the risks associated with construction in a space environment. The robotic system can be programmed to operate the implement with varying degrees of precision and can also be equipped with sensors to monitor the progress of the stabilization process. Additionally, the implement can be designed to be modular and portable, making it easy to transport to different locations on the lunar surface as needed. This embodiment enables a fully autonomous operation for regolith stabilization and construction on the lunar surface, enhancing the efficiency and safety of lunar infrastructure development.

### Sub-Embodiment 7.1 Autonomous Construction System with Digital Twin

An extension of Embodiment 5, wherein the system compares its positioning data with a digital twin that is informed by prior structural analysis. This analysis informs the mapping of polymer concentrations, allowing the delivery system to apply polymer additives precisely to areas of the regolith that require reinforcement and apply the specified levels of compaction and heating. This results in a more efficient use of materials and increased structural integrity.

### Embodiment 8: Thermal Generation Systems for Heating Engineered Regolith

This embodiment focuses on a passive solar thermal generation system for heating the regolith-polymer mix during construction. The primary objective is to ensure that the polymer binder is evenly activated, resulting in a more predictable and repeatable process. A secondary objective is to reduce energy demands on the process by utilizing concentrated sunlight.

Heat Generation and Transfer Mechanism: Solar concentrators, such as a parabolic trough, heliostat, or Fresnel lenses, are used to focus sunlight onto one or more solar collectors mounted on the outside of the formwork, warming a liquid medium contained in a reservoir of the solar collector. The heated liquid medium is pumped then through channels in a conductive formwork panel to ensure even heat distribution.

Selection of Liquid Medium: Considering the Moon's thermal environment with extreme temperatures ranging from −200° C. to 80° C., and process temperatures required to activate the polymer binder ranging from 80° C. to 150° C., the liquid medium material must remain in a significant liquid phase throughout these conditions. Perfluoropolyether (PFPE) exhibits exceptional thermal stability and remains liquid across a very broad temperature spectrum, typically from below −80° C. up to over 200° C. The use of PFPE as a liquid medium efficiently mitigates the risk of operational downtime during most lunar conditions, except for the extended cold periods of the lunar night when supplementary thermal management strategies may be required.

Liquid Metal Transfer: This method employs tubes filled with a liquid metal alloy, such as liquid sodium, to efficiently transfer heat from the solar receiver to the formwork. Liquid sodium is selected for its exceptional thermal conductivity, which enables rapid heat transfer, and its low melting point, ensuring operability across the extreme temperature fluctuations experienced on the lunar surface. For instance, liquid sodium typically maintains a liquid state within a wide temperature range, from approximately −50° C. to over 800° C., making it well-suited for lunar thermal management applications.

Supplemental Resistive Heating: This feature is strategically implemented within the formwork to maintain optimal operational temperatures for the heat transfer fluid, particularly during periods when ambient lunar temperatures drop too low for the fluid medium to remain in its liquid state. This approach utilizes resistive heating elements that are integrated into the formwork's conductive inner layer.

Formwork Materials: The heated formwork consists of a multi-layer assembly consisting of a conductive inner layer with a high conductivity to mass ratio, such as aluminum panel or copper mesh, and an outboard insulative layer design to prevent radiative heat loss, such as multi-layer insulation (MLI). Given the poor thermal conductivity of regolith, the formwork may incorporate retractable needles which penetrate through the surface layer to activate the regolith-polymer mixture at greater depth.

### Embodiment 9: System-Level Application of Engineered Regolith Techniques

This embodiment details a comprehensive system-level approach to constructing lunar infrastructures using engineered regolith. It integrates several previously described methods compaction, beneficiation, the use of polymer additives, and mesh reinforcement-to create a versatile construction toolkit. This integrated approach leverages the unique advantages of each method, enhancing the overall efficiency, durability, and performance of lunar structures.

Compaction: Begins with the fundamental process of mechanically compacting lunar regolith, which is optimized through the beneficiation process.

Beneficiation: Involves the additional precursor step of selectively sorting regolith particles to improve packing density and mechanical interlock, thus enhancing the base structural integrity.

Polymer Additives: Incorporates polymer additives, mixed in varying concentrations with the regolith to provide targeted enhancements in strength and environmental resistance. Higher concentrations are used near the surface layers or in areas subjected to higher stress to create a durable, protective crust.

Mesh Reinforcement: Integrates basalt or polymer mesh, which acts as a geogrid to distribute stresses and reinforce the regolith structure, particularly in load-bearing applications or where diagonal shearing forces are anticipated.

Temporary Formwork: Provides essential support to confine the regolith during compaction and heat activation, particularly when building vertical or complex geometric structures. Formwork systems are designed to be modular and adjustable, allowing them to be repositioned as construction progresses. This facilitates the creation of diverse structural forms by maintaining regolith in place until it has sufficiently hardened.

Heat Activation: Essential for activating the polymer additives within the regolith mixture, heat application is precisely controlled to ensure uniform activation and integration of the polymer into the regolith matrix. Embedded heating elements within the formwork or the construction implement can deliver localized heat, necessary for achieving optimal binder activation and curing of the regolith-polymer composite. This process not only solidifies the structure but also enhances its load-bearing capacity and environmental resilience.

System Integration and Application: The integration of these techniques into a single, cohesive construction methodology enables the tailored application of each to meet specific structural requirements. For instance, load-bearing walls may utilize all techniques for maximum strength and durability, while pathways may require less intensive applications. This flexibility allows for the strategic allocation of resources, optimizing construction efforts according to the demands of each project.

Example: The accompanying example presents the empirical evidence and benefits of this integrated system in different combinations, paving the way for targeted development of specific applications.

| | | Regolith | Other | Other | Yield | Ultimate | YS/ |
|---|---|---|---|---|---|---|---|
| | | mass | mass | MF. | strength | strength | baseline |
| | Description | (g) | (g) | (%) | (kPa) | (kPa) | (%) |
| 1 | Bulk (baseline) | 382.37 | | | 12.2 | 16.0 | n/a |
| 2 | Compacted | 474.5 | | | 49.0 | 66.26 | 402% |
| 4 | Basalt fiber (BF) only | 393.61 | 3.2 | 0.81% | 192.5 | 248.15 | 1578% |
| 5 | Compacted + BF | 474.5 | 3.2 | 0.67% | 395.0 | 472.92 | 3238% |
| 6 | Beneficiated, LPT | 436.88 | | | 37.5 | 38.98 | 307% |
| 7 | Beneficiated, FT | 436.88 | | | 88.65 | 101.39 | 727% |
| 8 | Compacted + PLAM | 474.5 | | | 614.0 | 731.46 | 5033% |
| 9 | Beneficiated, LPIF | 482.41 | | | 138.0 | 161.1 | 1131% |
| 10 | Beneficiated, LPIF + | 482.41 | 2.45 | 0.51% | 1300.0 | 1504.5 | 10656% |
| | PLAM | | | | | | |
| 11 | Beneficiated, LIPF + | 482.41 | 6.82 | 1.41% | 2000.0 | 2000.0 | 16393% |
| | PLAM v.2 | | | | | | |

LPOT Large particles on top
FOT Fines on top
LPIF Large particles with interstitial fines
PLAM PLA mesh
RC Relative compaction
MF Mass fraction
YS Yield strength

Conclusion: This embodiment encapsulates the strategic integration of multiple regolith manipulation techniques into a coherent system, providing a scalable and adaptable construction methodology for lunar infrastructure. By detailing how these technologies can be combined and applied in practical scenarios, this embodiment showcases the innovative potential of engineered regolith in supporting a sustainable human presence on extraterrestrial bodies.

### Embodiment 10: In-Situ Quality Control Methods for Engineered Regolith Construction

This embodiment introduces methods and equipment to implement in-situ quality control measures through all phases of construction, from soil analysis to sample preparation and testing:

In-situ Material Analysis: Core samples are extracted, weighed, and visually analyzed for particle size distribution. Small scale compaction tests are also performed to verify the relative compaction compared to the predicted level. In addition, periodic spectroscopy is performed to detect the presence of valuable resources, such as water, metals, and volatiles, that can be harvested before using the raw material for construction.

In-situ Sample Preparation and Testing: Small-scale samples or components are quickly tested and prepared, enabling engineers to test and validate the materials' properties and the construction methods before implementing them on a larger scale. An example is preparing a 100 to 200 mm (4″ to 8″) cylinder or conical sample of consolidated regolith-polymer and performing an unconfined soil compression test. By using this method, potential issues can be identified and addressed early in the development process, saving time and resources.

Prototype Construction and Performance Testing: A method of Embodiment 10, wherein a prototype is built for performance testing prior to full-scale construction. This prototype is designed to replicate the conditions and materials of the final structure to test the effectiveness of the regolith stabilization method and the materials used. The prototype is subjected to a battery of tests, including environmental testing, load testing, and other performance tests to assess the strength and durability of the construction. This testing ensures that any issues are identified and addressed before the full-scale construction process begins, saving time and resources.

Real-time Monitoring: A method of Embodiment 10, wherein sensors and other monitoring equipment are installed on the regolith structures to track their performance in real-time. This provides continuous feedback on the stability and integrity of the structures and can alert engineers to any issues that may arise. Real-time monitoring provides early detection of any potential failures, minimizing the risk of catastrophic events.

Quality Control Documentation: A method of Embodiment 10, wherein all quality control measures are documented and stored in a centralized database, providing a comprehensive record of the construction process. This documentation can be used to track any changes, identify potential issues, and evaluate the overall quality of the completed structures. Quality control documentation is used to ensure compliance with construction specifications and provides a valuable resource for future construction projects.

### Embodiment 11: Non-Destructive Evaluation of Engineered Regolith Structures

In this embodiment, non-destructive evaluation (NDE) methods are employed to assess the integrity and stability of regolith structures during and after construction. The NDE techniques provide real-time and accurate information on the properties of the regolith, allowing for timely detection of any defects or structural problems. These methods may include:
Ultrasonic Testing (UT), which uses high-frequency sound waves to detect internal defects in the regolith structures. The sound waves are transmitted through the regolith and are reflected back by any internal discontinuities or voids, providing information on their size, shape, and location;
Ground-Penetrating Radar (GPR), which uses electromagnetic radiation to detect changes in the dielectric properties of the regolith. The technique provides information on the internal structure of the regolith, including the presence of voids, cracks, and other defects;
X-ray Tomography (XT), which uses X-rays to create a three-dimensional image of the internal structure of the regolith. The technique provides detailed information on the density, composition, and distribution of the regolith, allowing for the detection of any internal defects or structural problems;
Infrared Thermography (IRT), which uses infrared cameras to detect changes in temperature on the surface of the regolith structures. The technique provides information on the distribution of heat within the structure, which can be used to detect any internal defects or structural problems.

### Embodiment 12: Maintenance, Inspection, and Repair of Engineered Regolith Structures

This embodiment highlights the importance of ongoing maintenance, inspection, and repair for the sustainability and longevity of lunar regolith-based structures. By incorporating advanced materials, equipment, and repair techniques, the structures can be maintained and repaired efficiently, minimizing downtime and ensuring the continued success of lunar missions.

In-situ Inspection and Monitoring: Sensors and other monitoring equipment are installed within the regolith-based structures to enable in-situ inspection and monitoring. These sensors can detect structural changes or damage caused by exposure to the lunar environment, providing real-time data for evaluating the health and stability of the structures. In one variation, a machine learning algorithm is trained to identify and classify cracks and other defects.

Robotic Maintenance and Repair: A robotic system is used for maintenance and repair of regolith-based structures. The robotic system can be programmed to perform routine inspections and maintenance tasks, as well as repairs to any damage detected during inspections. This reduces the need for human intervention and minimizes the risk associated with conducting repairs on the lunar surface.

Rapid Repair and Replacement: Rapid repair and replacement techniques are employed to address any structural damages or failures. One example is prefabricated regolith-based components that can be easily transported to the damaged site and quickly assembled to replace the damaged sections. Another example is regolith injection, which involves injecting regolith-polymer mixture into damaged areas to restore structural integrity.

Self-Repairing Construction Materials: Regolith-based construction materials are engineered to possess self-repairing properties. This can be achieved by incorporating advanced polymeric additives or other self-healing agents into the regolith mixture. When damage occurs, these agents can react and restore the material's properties, enhancing the durability and longevity of the constructed lunar infrastructure.

Phase Change Material Additives: Phase change materials (PCMs) are incorporated into the regolith stabilization process. PCMs can store and release thermal energy when transitioning between solid and liquid states, allowing them to help regulate temperature fluctuations within the regolith-based structures. This could be particularly useful for structures exposed to extreme thermal variations on the lunar surface. PCMs could be integrated into the polymeric or geopolymer additives or applied separately within the regolith mixture.

### Embodiment 13: Mars-Adapted Engineered Regolith Construction

Mars presents unique challenges compared to the lunar environment, such as differences in gravity, thermal environment, and atmosphere. Martian regolith also has distinct properties compared to lunar regolith, requiring adaptations in the construction technology to ensure optimal performance. In this embodiment, we describe a Mars-adapted regolith construction technology that addresses these challenges and enables the construction of long-term infrastructure on the Red Planet:

Mars Regolith Composition and Properties: The regolith on Mars is composed of different materials and minerals than that on the Moon and has different physical properties. For example, Martian regolith contains a higher percentage of iron oxide, which affects its color and magnetic properties. Additionally, the Martian environment experiences more frequent and intense dust storms, which can affect the properties of the regolith. In this sub-embodiment, the properties of Martian regolith are studied and analyzed to determine the optimal materials and additives to be used in the regolith construction process.

Mars Site Selection and Preparation: The process of selecting and preparing the construction site on Mars is different from that on the Moon due to the differences in topography, geology, and atmospheric conditions. In this sub-embodiment, an autonomous site selection and preparation system is developed to identify suitable locations for the construction and prepare the site for the deployment of construction equipment.

Equipment Design and Optimization for Martian Environments: The equipment used for regolith construction on Mars must be optimized for the unique properties of Martian regolith and the environmental conditions on the planet. For example, the design of excavation and mixing implements must consider the increased density and strength of Martian regolith compared to lunar regolith. Additionally, the equipment must be designed to withstand the harsh Martian environment, including dust storms, temperature variations, and radiation. In this sub-embodiment, the construction equipment is designed and optimized for use on the Martian surface.

Material Selection and Formulation: The selection and formulation of materials used in the regolith construction process must be adjusted for use on Mars. In this sub-embodiment, alternative additives and binders are studied and tested to determine their effectiveness in the Martian environment. Additionally, the use of local Martian resources, such as water and carbon dioxide, is considered to reduce the need for transportation of materials from Earth.

Polymer Synthesis from Martian Atmosphere: The focus of this embodiment is on the synthesis of polymers from the Martian atmosphere, specifically using carbon dioxide (CO2) as a feedstock. Unlike the lunar environment, Mars has a thin atmosphere consisting mostly of CO2, which can be utilized as a source of carbon for polymer synthesis.

One approach to polymer synthesis on Mars involves using the Sabatier reaction, which converts CO2 and hydrogen (H2) into methane (CH4) and water (H2O). The methane can then be converted into ethylene (C2H4) and other hydrocarbons using various catalytic processes, including Fischer-Tropsch synthesis. Once the ethylene is obtained, it can be polymerized into various types of polymers using different polymerization methods, such as Ziegler-Natta polymerization.

Another second approach to polymer synthesis on Mars involves harvesting microbial cultures to yield EPS as described in Embodiment 2.3. This process is ideally suited to the Martian environment where microbial cultures can efficiently carbon-fix CO2. The setup for EPS production can be relatively straightforward as bioreactors could be placed underground or within Martian caves to shield them from radiation, capitalizing on the natural environmental conditions to support growth. The EPS production process operates at moderate temperatures, typically between 60-80° C., which is significantly lower compared to more energy-intensive methods such as laser sintering or thermoplastic extrusion, making it a particularly practical and sustainable option for Mars.

Construction Process Adaptation for Mars: The regolith construction process must be adapted for use on Mars, considering the differences in regolith properties, environmental conditions, and equipment design. In this sub-embodiment, the construction process is studied and modified to optimize its efficiency and effectiveness on the Martian surface. For example, the use of robotic automation and artificial intelligence is explored to reduce the need for human presence on the planet.

1: A system of lunar infrastructure constructed using engineered regolith, the infrastructure comprising: launch and landing facilities, equipment and operational support structures, transportation and access networks, and habitation and protective installations.

2: A method for constructing lunar infrastructure using engineered regolith, comprising: selecting a combination of regolith enhancement techniques based on predetermined structural requirements; applying selected techniques in a sequence to optimize the mechanical properties of the regolith; and integrating the techniques to form a cohesive construction methodology.

3: An apparatus for constructing lunar infrastructure using engineered regolith, the apparatus comprising: means for compacting regolith, means for applying polymer additives, means for integrating mesh reinforcement, and means for activating heat within the regolith, wherein the apparatus is configured to implement the method of claim 2.

4: The method of claim 2, wherein the regolith enhancement techniques include any combination of compaction, beneficiation, incorporation of polymer additives, mesh reinforcement, and heat activation, which serve to confine regolith under applied loads, thereby improving cohesion, frictional shear strength, yield strength, and ultimate compressive strength.

5: The method of claim 2, wherein the effectiveness of combining compaction, beneficiation, incorporation of polymer additives, and mesh reinforcement techniques is validated by empirical data from unconstrained soil tests in a laboratory setting, demonstrating improvements in yield strength and ultimate compressive strength by at least 1000% compared to samples constructed from untreated regolith.

6: The method of claim 2, wherein beneficiation involves sorting regolith particles into a defined size range to optimize packing density and mechanical interlock, thereby enhancing the base structural integrity of the constructed forms, including sorting the particles to retain those within a 0.5 mm to 2 mm range and using 40-60% of the fines smaller than 0.5 mm to optimally fill the interstitial voids.

7: The method of claim 2, wherein mesh reinforcement involves the integration of an engineered mesh specifically designed to conform to the stress profiles of the intended structure and the specific regolith particle size distribution used, including a diagrid pattern with triangular windows optimally sized to complement the selected size range of the beneficiated regolith, enhancing interlock and structural integrity.

8: The method of claim 7, wherein the engineered mesh includes lines of reinforcement aligned with anticipated stress patterns and can be manufactured using processes capable of achieving precise design specifications required for optimal performance, including 3D printing, stamping, or rolling.

9: The method of claim 2, wherein polymer additives are mixed with the regolith in concentrations varying based on location within the structure to provide targeted enhancements in strength and surface durability, typically within the range of 0.5-2%.

10: The method of claim 2, wherein the selection of techniques is dynamically adapted based on the specific requirements of different infrastructure types including load-bearing structures such as launch pads and communication towers, which require a full suite of techniques for maximum strength; transportation infrastructures like roads and pathways, where a more focused application of techniques suffices to achieve required durability and trafficability; and habitation infrastructures where enhanced protective measures are integrated, such as meteoroid impact protection and radiation shielding, to ensure safety and operational integrity.

11: The method of claim 2, wherein the integrated approach allows for strategic allocation of resources, optimizing construction efforts according to the demands of each project, and enabling the tailored application of each technique.

12: An apparatus of claim 3 for compacting engineered regolith as part of lunar construction, comprising: a compaction unit capable of applying continuous or intermittent force; a heating mechanism integrated within the compaction unit for activating polymer additives within the regolith; and a control system configured to adjust the compaction force and heat application based on predetermined regolith properties to optimize the mechanical properties of the engineered regolith.

13: An apparatus of claim 3 for constructing three-dimensional structures from engineered regolith, comprising: adjustable and repositionable formwork panels; integrated heating elements within the panels to activate polymer additives during regolith setting; and a modular assembly allowing for the configuration of the formwork to various geometric shapes according to specific construction requirements.

14: An apparatus of claim 3, configured as a delivery system for engineered regolith designed for lunar construction, comprising a storage unit for holding premixed regolith with varying concentrations of polymer additives, a conveying mechanism that transports regolith from the storage unit to the construction site, and a dispensing unit that precisely controls the release and distribution of regolith according to structural analysis or specific application needs such as targeted reinforcement or surface finishing.

15: A system of infrastructure construction using engineered regolith adapted for Martian environments, wherein the material, methods and apparatus developed for the enhancement of lunar regolith is transferable to Mars and optimized for key differences in gravity, regolith properties, and atmospheric conditions; notably, where atmospheric CO2 can be used as a carbon source to produce polymers synthetically or biologically through microbial cultures, enabling scalable regolith infrastructure construction through the efficient use of in-situ resources.
